(19) United States
(12) Patent Application Publication
(10) Pub. No.: US 2024/0249507 A1
(43) Pub. Date: Jul. 25, 2024

(54) METHOD AND SYSTEM FOR DATASET SYNTHESIS

(71) Applicants: Sony Interactive Entertainment Europe Limited, London (GB); Sony Interactive Entertainment LLC, San Mateo, CA (US)

(72) Inventors: Lloyd Preston STEMPLE, London (GB); Aron Giuseppe VISCIGLIA, London (GB); Daisuke KAWAMURA, London (GB); Ramanath BHAT, London (GB); Pedro Federico Quijada LEYTON, London (GB); David Erwan Damien UBERTI, London (GB)

(73) Assignees: Sony Interactive Entertainment Europe Limited, London (GB); Sony Interactive Entertainment LLC, San Mateo, CA (US)

(21) Appl. No.: 18/414,863

(22) Filed: Jan. 17, 2024

(30) Foreign Application Priority Data
Jan. 19, 2023 (GB) 2300819.6

(51) Int. Cl. G06V 10/774; G06T 17/20; G06V 10/776; G06V 40/16

(52) U.S. Cl. CPC G06V 10/774; G06T 17/20; G06V 10/776; G06V 40/161; G06V 40/171

(57) ABSTRACT

A method of dataset generation is described. The method comprises steps including receiving user image data and generating personalised training data based on the received user image data. Generating personalised training data comprises generating a computational model based at least in part on the received user data and generating the personalised training data based on the computational model.

### CROSS-REFERENCE TO RELATED APPLICATIONS

The present application claims priority from British Patent Application no. 2300819.6 filed Jan. 19, 2023, the contents of which are incorporated herein by reference in its entirety.

### FIELD

The present disclosure relates to a method and a system for synthesising data to supplement and enhance real world data. More particularity, the present disclosure provides data synthesis for the purposes of training machine learning based systems.

### BACKGROUND

Machine learning systems, and in particular machine learning systems that involve artificial neural networks need training data such that they can be usefully used. Further, the quality and quantity of the training data can impact on both the amount of training that can be done and influence the ability for the machine learning system to conduct inference at a later stage.

Obtaining training data can be difficult because of the sheer amount of data required to train a machine learning model effectively. Further to this, even after one has captured a large amount of good data, it must be labelled. Manual labelling of said data can be an arduous task largely because of said sheer volume and the requirement a human is involved in the labelling.

Labelling data is the process of assigning a meaning or inference to data for the purposes of training a machine learning model. Data labels are usually stored alongside the data as metadata. As an example, a data label might indicate whether a photo contains a cat or a dog, whether a user sounds angry or sad in an audio sample, or what the sentiment is of a headline. As set out above, labels can be obtained from humans directly by asking them to infer what an image contains. A further option is to provide a guess at a label contains and ask a human to confirm or correct the label.

Synthetic data, though cheap and easier to produce can have issues when it is the only source of data used (or even if only part of the data used is synthetically generated). There can be problems overcoming this “synth to real” gap.

Aspects and embodiments were conceived with the foregoing in mind.

### SUMMARY OF THE INVENTION

According to a first embodiment of a first aspect, there is provided a method of dataset generation, the method comprising receiving user image data, and generating personalised training data based on the received user image data, wherein the step of generating personalised training data comprises: generating a computational model based at least in part on the received user data, and generating the personalised training data based on the computational model.

Advantageously, use of real and synthetic data as described herein allows for more training data and more accurate training data while still being both automatically generated and labelled. This all allows for quicker model generation by removing additional computational time labelling data.

Optionally, the computational model is facial mesh comprising a real-world 3D topology, wherein the real-world 3D topology is based on the received user image data.

Optionally, the computation model comprises a facial mesh and a skin based on real-world skin, wherein the real-world skin is based on the received user image data.

Advantageously, the use of real-world user data enables computational models which are more accurate to real-world features and thus can be used to generate more accurate training data.

Optionally, the personalised training data is labelled based on the computation model.

Advantageously, basing the automatic labelling of the training data on the inputs to the computational model allows for more accurate training data to be produced (and therefore improved machine learning models). Further, labelling according to how the data was produced (for example by highlighting that the 3D mesh is not from the user) ensures any training process that uses this data uses it and/or trains with it appropriately.

Optionally, generating the personalised training data comprises capturing a plurality of views of the computation model from different viewing angles, and/or capturing a plurality of views of the computation model under different lighting conditions.

Advantageously, with the rendered computation model, multiple and varied views of the partially synthetic, partially real user face can be obtained without interaction from the user.

Optionally, personalised training data is labelled based on camera placement, and/or lighting features used in capturing the views of the computational model.

Camera placement can also be considered a viewing angle.

Advantageously, conducting automatic labelling based on inputs to the semi-synthetic model generation allows for quicker and more computationally efficient training data generation.

Optionally, the personalised training data is based on a parameterised input, wherein the parameterised input represents an area of interest of the user. Optionally, the parameterised input represents any one or more of the following: a facial feature of the user, facial hair of the user, hair of the user, an item of clothing worn by the user, an accessory worn by the user, glasses worn by the user, and a hat worn by the user. Optionally, generating the personalised training data comprises capturing a plurality of views of the computation model, wherein the computation model is based on the parameterised input. Optionally, the parameterised input further comprises emotion information.

Optionally, the personalised training data is labelled based on the parameterised input.

Advantageously, the use of parameterised input(s) allows for more flexible computational model generation and rendering thereby increasing the amount of useful data that can be generated. With more data, that is known to be accurate and appropriate to the user, better models can then be trained.

Optionally, the received user image data is processed to crop and select an area of interest of the user. Preferably, the area of interest comprises the user's face and other surrounding user features. Preferably, the area of interest comprises the user's face and any one or more of the following: a facial feature of the user, facial hair of the user, hair of the user, an item of clothing worn by the user, an accessory worn by the user, glasses worn by the user, and a hat worn by the user.

Advantageously, cropping (and any other pre-processing) reduces the amount of data needing to be processed. Cropping (and other pre-processing steps) is a less computationally intensive operation (as compared with topology extraction or obtaining skin data based on the user image) that provides a smaller image for the more computationally intensive steps.

Optionally, the method further comprises the step of receiving a personalised machine learning model. Preferably, the personalised machine learning model is based on the personalised training data. More preferably, the personalised machine learning model has been trained using the personalised training data.

Optionally, the personalised machine learning model replaces a previous machine learning model based on a comparison between the generated personalised machine learning model and the previously generated machine learning model. Preferably, the comparison comprises determining which of the machine learning models provides more accurate outputs.

According to a further embodiment of the first aspect, there is provided an electronic device comprising a processor configured to perform a method according to the first aspect.

According to a further embodiment of the first aspect, there is provided a computer program product comprising instructions which, when the program is executed by a computer, cause the computer to carry out a method according to the first aspect.

According to a further embodiment of the first aspect, there is provided a computer-readable storage medium comprising instructions which, when executed by a computer, cause the computer to carry out a method according to the first aspect.

According to a first embodiment of a second aspect, there is provided a method of dataset generation and model personalisation, the method comprising receiving personalised training data, and generating a personalised machine learning model by training a general purpose machine learning model based on the personalised training data and based on baseline training data.

Advantageously, obtaining a machine learning model that has been generated using personalised training data provides a more accurate (for the individual) machine learning model.

Optionally, the personalised machine learning model replaces a previous machine learning model based on a comparison between the generated personalised machine learning model and the previously generated machine learning model. Preferably, the comparison comprises determining which of the machine learning models provides more accurate outputs. Preferably, the comparison is conducted using an A/B test with outputs of each machine learning model and/or outputs of an inference step using each machine learning model.

Optionally, the method further comprises the step of conducting an inference step using a first machine learning model, and wherein the generation of a personalised machine learning model is conducted based on a detection or determination that an output of the inference step is below a threshold accuracy level. Optionally, the detection or determination is based on the user providing an input that indicates the accuracy is below a threshold accuracy level.

Optionally, the personalised training data is generated according to a method of the first aspect.

According to a further embodiment of the second aspect, there is provided an electronic device comprising a processor configured to perform a method according to the second aspect.

According to a further embodiment of the second aspect, there is provided a computer program product comprising instructions which, when the program is executed by a computer, cause the computer to carry out a method according to the second aspect.

According to a further embodiment of the second aspect, there is provided a computer-readable storage medium comprising instructions which, when executed by a computer, cause the computer to carry out a method according to the second aspect.

According to a third aspect, there is provided a system for data generation and model personalisation comprising a first electronic device according to the first aspect which comprises a processor configured to perform a method according to first aspect, and a second electronic device according to the second aspect operatively coupled to the first electronic device, the second device comprising a processor configured to perform a method according to the second aspect.

Preferably, the first electronic device is configured to generate personalised training data, and wherein the second electronic device is configured to receive the personalised training data, generate a new personal machine learning model and provide the new personal machine learning model to the first electronic device.

As is described herein, the first aspect optionally comprises all or some of the method steps of the second aspect.

Optionally and according to any one or more of the preceding aspects, the steps of generating personalised training data and generating a personal machine learning model are conducted asynchronously and/or in the background while inference is being conducted. Advantageously, conducting training and/or image generation in the background will allow any current active application(s) being run on the device to not be affected.

Additionally or alternatively, and according to any one or more of the preceding aspects, the user data is voice data. Here, a machine learning model to be trained is configured to extract emotion out of a user's voice which can then also be provided to a user avatar to assist in mood prediction such that the avatar more accurately represents the user's mood. Similar to the image inference example used throughout, the personalised training data is generated by simulating, at least in part, the user's voice expressing different emotions.

Optionally, and according to any one or more of the preceding aspects, the labelling is conducted such that no manual interaction is required. Optionally, the labelling is automatic such that no human interaction is required.

Advantageously, the present aspects enable automatic generation of personalised training data. This is of specific advantage as many or most of the prior art systems currently are at best semi-automated. Many of these prior art methods require a manual step of labelling image data create an annotated data set. The use of automated/programmed parameterised inputs, computation models, camera placement, and relighting (as described herein) enable the generation and labelling in an automated fashion.

Every user could start with the same generalised machine learning model, however, over time, use of the embodiments described herein would generate variants of that machine learning model personalised to the user through the generation of their own personalised dataset and through further training of their own machine learning model in place of the generic one.

Machine learning models may comprise an artificial neural network (ANN). The ANN can be one of any number different architectures including a Feed Forward Network (FF), a Multilayer Perceptron (MLP) (which is an even more specific example architecture of an FF network), a Convolutional Neural Network (CNN), a Recurrent Neural Network (RNN), Long short-term memory (LSTM), an Autoencoder, or a Deep Belief Network. Other topologies and variations of the models listed above are also possible.

ANNs can be hardware- (neurons are represented by physical components) or software-based (computer models) and can use a variety of topologies and learning algorithms.

ANNs usually have at least three layers that are interconnected. The first layer consists of input neurons. Those neurons send data on to the second layer, referred to a hidden layer which implements a function and which in turn sends the output neurons to the third layer. There may be a plurality of hidden layers in the ANN. With respect to the number of neurons in the input layer, this parameter is based on training data.

The second or hidden layer in a neural network implements one or more functions. For example, the function or functions may each compute a linear transformation or a classification of the previous layer or compute logical functions. For instance, considering that the input vector can be represented as x, the hidden layer functions as h and the output as y, then the ANN may be understood as implementing a function f using the second or hidden layer that maps from x to h and another function g that maps from h to y. So the hidden layer's activation is f(x) and the output of the network is g(f(x)).

Machine learning models, and in particular ANNs, may be trained using labelled and/or example data relating to the purpose the ANN is being used for (i.e. example face area detection data is used to train for detecting specific face areas or example mood detection data is used to train for detecting mood). The training may be implemented using feedforward and backpropagation techniques.

Some specific components and embodiments of the disclosed method are now described by way of illustration with reference to the accompanying drawings, in which like reference numerals refer to like features.

### BRIEF DESCRIPTION OF THE FIGURES

FIG. 1 depicts a dataflow according to an example embodiment described herein.

FIG. 2 depicts a system diagram according to an example embodiment described herein.

FIGS. 3 to 5 depict flow diagrams illustrating method steps according to various embodiments described herein.

FIG. 6 depicts a block diagram illustrating an example electronic device as described herein.

### DETAILED DESCRIPTION

The need for reliable training data is a constant to those designing and training machine learning models. Obtaining this data can be a costly and labour intensive process which requires manual labelling of data. This need becomes more relevant as the prevalence of machine learning increases. Further still as machine learning is used in more and more applications in user's lives, specificity to user features is also required.

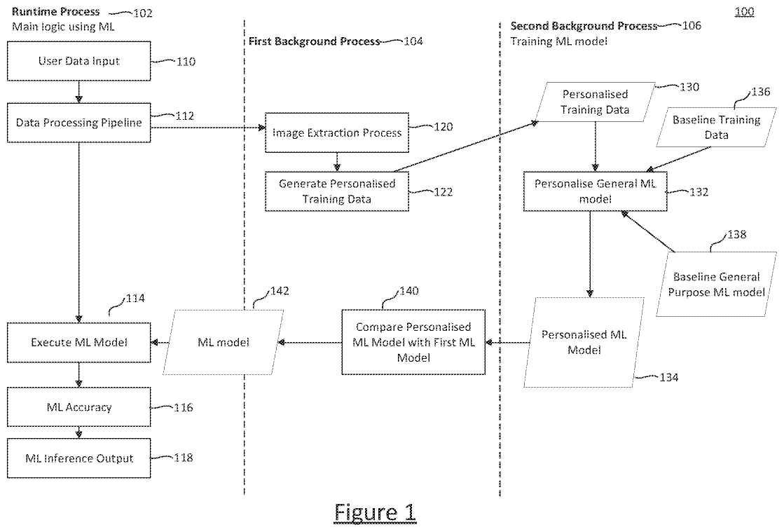

An example application where this is required is the generation of personalised avatars, optionally in a gaming context. As is described with reference to FIG. 1, a runtime process 102 is described where camera data is received, processed, then machine learning is applied to extract user features, and that machine learning output is provided to an avatar generation step. In particular, the machine learning model of this example is a facial attributes classifier model and an emotional inference model. With facial attributes and emotions extracted/inferred, an avatar is generated that matches said attributes and emotions. Accurate determination of these features enables an avatar to be generated that is closer aligned with the user the avatar is representing. A person skilled in the art will appreciate that other runtime processes involving machine learning models may also benefit from the embodiments described herein. Such other systems could include:
detecting user (or users) voices for voice recognition from received user voice data,
detecting newly developed objects for which large amounts of training data have not been captured yet, and
assistance in detecting particularly difficult to navigate roads for self-driving cars where not enough detailed and varied (for example varied with different lighting conditions) data is collected.

Referring to FIG. 1, an example data flow 100 is shown. While the data flow illustrates data inputs, outputs, and processing steps, a skilled person will appreciate that these can also represent method steps. The example data flow is preferably conducted at different times and optionally across different devices. Preferably, three processes 102, 104, 106 are shown: The runtime process 102 which comprises the main logic using machine learning, the first background process 104 which comprises generation of personalised training data, and the second background process 106 which comprises the generation of a personalised machine learning model. The second background process 106 can be conducted on the device conducting the main process in the background (and optionally asynchronously) or on a separate device or server optionally in the cloud. The three processes are delineated in the figure by dashed lines.

According to the main example usage of this system as set out above, the runtime process is configured to receive user image data (and preferably facial data with surrounding regions of the user's face), extract facial features and/or areas of interest of the user using machine learning, and provide the output of the machine learning step to generate an avatar. In a first step of the main process 102, user data is received 110. Preferably, user data is image or video data of a user. Next, the user data is processed 112 in a data processing pipeline.

Optionally, this data processing pipeline includes cropping and selecting to include any relevant areas of interest of the user. Optionally the data processing step also selects said areas of interest and provides coordinates indicates where the areas of interest are in the image data.

Areas of interest of a user depend on the application the present description is used in. In the user avatar example, areas of interest comprise a user's face and optionally any one or more of the following: a facial feature of the user, facial hair of the user, hair of the user, an item of clothing worn by the user, an accessory worn by the user, glasses worn by the user, and a hat worn by the user.

The output of the data processing pipeline is preferably provided to the first background process 104 as well as provided to execute machine learning 114 using a first, pre-existing, machine learning model.

Optionally, a level of accuracy of the machine learning output is determined 116. Where the accuracy is too low, this triggers the first background process 104 as this is an indication that the first machine learning model is not operating as well as it could and there may be an opportunity to obtain a new one that does perform better.

The inference conducted by the machine learning model is output 118 to the next process. In the main example usage, the next process is generation of an avatar that uses the inference output.

As set out above, the first background process 104 is optionally triggered when the machine learning accuracy 116 of the runtime process 102 is detected to be below a threshold (i.e. not accurate enough). Alternatively, the first background process is trigger upon presentation of A/B testing (as discussed below) and optionally the A/B testing is presented periodically. Alternatively, the first background process is triggered periodically. Alternatively, the first background process is triggered by a user inputting that the machine learning model is not accurate enough. Alternatively, the first background process is trigger by an external source. An external source may trigger the first background process when more and/or better training data is available and/or when a better base model is available. Alternatively, any one or more of said triggers may be used to trigger the first background process.

Preferably, the first background process 104 receives or obtains processed user data. Alternatively, the first background process receives or obtains user data. Optionally, the processed user data is obtained from a storage associated with the device conducting the runtime process 102. Where the processed user data is video data, an image extraction step 120 is conducted such that only select frames of the video are used. Preferably the image extraction process also selects frames that allow for better feature extraction. For example, blurry frames are removed and or frames with poor lighting are removed. Optionally, the reception of user data and image extraction step 120 is conducted continually and/or periodically in the background. In this embodiment, the output of the image extraction step is cached such that the higher quality user data is stored and accessible for later personalised training data generation. This way, a high quality dataset is maintained for future use when the generation of personalised training data is triggered according to any one or more of triggers set out in the preceding paragraph.

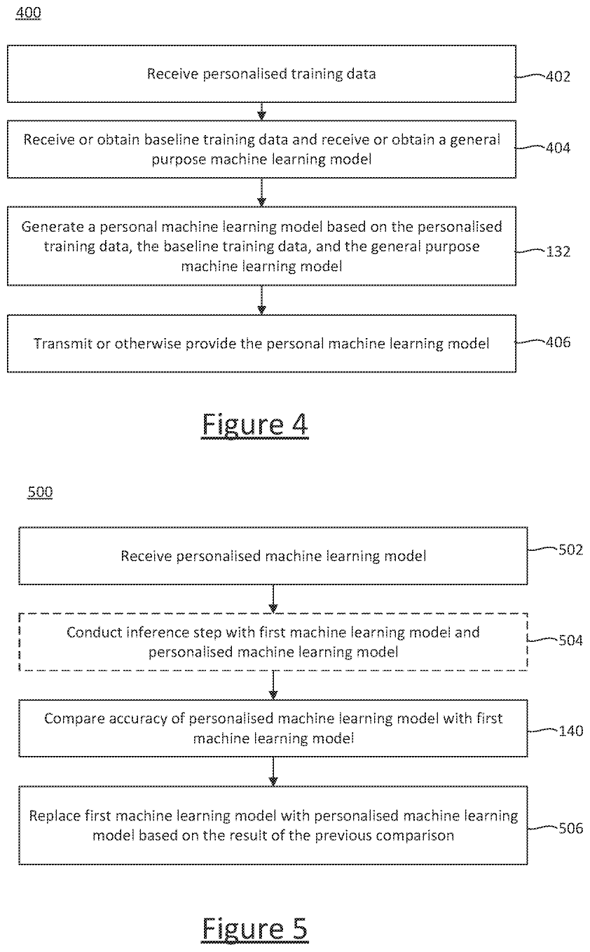

With the processed user data, a personalised training data is generated 122. Preferably, the personalised data is generated according to the embodiment described with reference to FIG. 3. The personalised training data is provided to the second background process 106.

The second background process 106 receives the personalised training data 130. A personalised general machine learning model 134 is generated 132. The process of generating a personalised machine learning model takes a baseline general purpose machine learning model 134 and trains it with the received personalised training data and baseline training data 136.

The specific training that occurs during the generation of the personalised machine learning model depends on the final purpose of the personalised machine learning model. Where the model is used for facial feature identification and/or extraction in the process of avatar generation, then the personalised machine learning model is trained according to that purpose and using appropriately labelled data.

The trained personalised machine learning model 134 is provided to the first background process 104 which conducts a comparison 140 with the previously used machine learning model. The comparison is based on the accuracy of the first machine learning model (currently being used) and the newly generated personalised machine learning model. The machine learning model 142 used in the runtime process 102 is then updated based on the outcome of the comparison step.

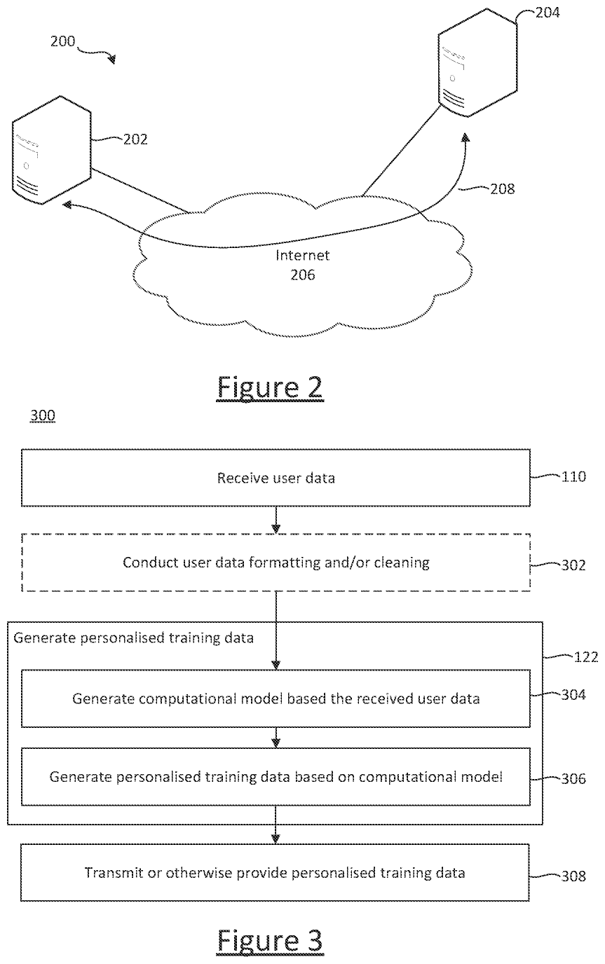

Referring to FIG. 2, an example system 200 is shown comprising an electronic device 202 and a server 204. The electronic device and server are operatively coupled over the internet 206. The system illustrates an embodiment where the electronic device conducts the runtime process 102 and the first background process 104 and the server conducts the second background process 106. The electronic device and the server communicate 208 over the internet so that the electronic device can send personalised training data to the sever and the server can send the trained machine learning model to the electronic device. Preferably, the first background process is conducted while the electronic device 202 is not actively in use by a user and/or in a sleep mode.

Advantageously, conducting the CPU intensive task of training a machine learning model asynchronously on a server 204 enable the electronic device to continue conducting the runtime process 102 using all of the CPU power available thereby improving the experience for a user using the electronic device.

Alternative to the system described in FIG. 2, the electronic device 202 is configured to conduct all of the runtime process 102, the first background process 104, and the second background process 106. Preferably the first and/or second background processes are conducted when a runtime process is not being conducted. This might be when the electronic device is not in use by a user and/or in a sleep mode.

Advantageously, conducting all of this data processing locally on the electronic device increases the privacy of the overall system as no personal data will ever leave the device. Conducting the CPU intensive tasks while the electronic device 202 is not in active use is a form of load balancing that ensures the end user experience is not affected while still enabling the system to generate improved machine learning models.

Optionally, all of the personalised data is encrypted at rest thereby further increasing the security of user related data.

Referring to FIG. 3, an example method 300 of generating personalised data is shown. The same or similar reference numerals have been used with the same or similar method steps of FIG. 1. As discussed above with reference to FIG. 1, this method comprises some steps from the first background process 104. Firstly, user data is received 110. This data is preferably image data and/or video data from a camera associated with the electronic device 202. Preferably, the user data captures the face of the user. More preferably, the user data comprises areas of interest as set out above.

Optionally, the user data is processed 302 to format it and/or clean it such that it can be used in a next step. Preferably this step comprises cropping. Preferably this step comprises selecting area(s) of interest of the user. Where the input is a video input, this step preferably comprises selecting frames of video. More preferably, frames are selected/process as described with reference to the images extraction process 120 of FIG. 1. Preferably, frames that show the user more clearly are selected such that the user's features can be identified.

Next, with the user data optionally cleaned and formatted properly, the personalised training data is generated 122. Preferably, generation of personalised training data comprises two steps: generating 304 a computation model based on the user data, and subsequent generation of the personalised training data based on the computation model 306.

Preferably, the computational model is a facial mesh comprising a real-world topology based on the received user data. More preferably, the received user data is processed such that the 3D topology is extracted. Optionally, the user data comprises topology information such as data captured from a 3D stereo camera. Alternatively or additionally, where the topology data is not available or cannot be generated, pre-generated and/or standard facial topologies are used. The personalised training data is labelled (for the purposes of later training) based on the topology used and how the topology is derived. In particular, the personalised training data is labelled when a non-personalised topology is used. This is important for when used in training as the personalised training data based on the non-personalised topology would not provide any useful data for identifying an individual's facial topology.

Preferably, the computation model comprises skin data from the user data such that the computational model's skin is based on the user's real world skin. Preferably, the user data is processed to extract the skin surface features (colour, blemishes, scars, etc) and this is applied to the computational model's facial mesh. Optionally, where skin data is not available or otherwise cannot accurately applied to the facial mesh, synthetic skin is used. The personalised training data is labelled (for the purposes of later training) based on the skin used and how the skin is derived. In particular, the personalised training data is labelled when a non-personalised (i.e. synthetic) skin is used. This is important for when used in training as the personalised training data based on the non-personalised topology would not provide any useful input to the identification of an individual's face based on their skin.

Optionally, the computation model is also modified according to a parameterised input. Preferably the parameterised input describes a way a personalised training image could be generated based on areas of interest. Preferably, a parameterised input can represent any one or more of the following: a facial feature of the user, facial hair of the user, hair of the user, an item of clothing worn by the user, an accessory worn by the user, glasses worn by the user, and a hat worn by the user. Preferably, the parameterised input selects synthetic inputs for the computation model. That is to say, were the parameterised input to indicate a particular shape and style of facial hair, the computation model would be generated to include said facial hair indicated by the parametric input. Preferably, the personalised training data is labelled according to the parameterised input.

Optionally, the parameterised input also represents an emotion. This way the facial mesh computational model is manipulated according to the parameterised input.

The parameterised input(s) can be varied by selecting different and/or multiple different inputs at a time.

With the computational model preferably based on the facial topology of the user, the skin surface features, and parameterised input(s), a semi-real and semi-synthetic representation of the user's face is rendered. This rendering is then used to generate personalised training data. Here, rendering can also be considered or described as “synthesizing”. The terms render and synthesize preferably refer to the generation of new image data being create as a surrogate and/or supplemental to real image (RGB/pixel) data

Using the rendered computational model, different views taken at different angles of the model are captured. These different rendered views are stored along with any labels associated with the view itself (such as angle taken) and any labels associated with the computational model (as set out above). The personalised training data comprises all of the captured views and their associated labels.

As a part of the rendering and capturing process, lighting of the computational model can also be varied. The direction, position and intensity of a light source can be varied. Different numbers of light sources can also be used. The information about the lighting being used for rendering and capture is also captured and provided as a label to the outputted personalised data.

It can be seen that there is a large amount of flexibility in the types of rendering available with a computational model. All of the lighting, the viewing angle, and the parameterised inputs which enable different hair styles and emotions (among other things as discussed above) can be varied. Advantageously, the computational models are based on both real world data (facial topology and skin) and synthetic data (re-rendering with different lighting, angles, and parameterised inputs). The combination of both personalised, real-world data with synthetic data goes some way to overcome the problems associated with the “synth to real” gap.

The combination of synthetic and real data enables highly accurate, automated labelling of image training data, while still being based on real-world relevant images (or at least based on real-world relevant images).

Thus, with the ability to automatically generate personalised training data, a given amount of personalised training data is generated. The precise number of variations (and therefore amount of training data) is selectable and will depend on the accuracy required as well as the processing power available. Preferably, no fewer than a thousand personalised training images are generated.

Finally, with an appropriate amount of personalised training data obtained, the personalised training data is made available 308 to a machine learning process. Preferably the personalised training data is provided to the server 204. Alternatively, it is stored on a memory of the computing device 202 for access by a machine learning training process.

Referring to FIG. 4, an example method 400 of training a machine learning model using personalised training data. The same or similar reference numerals have been used with the same or similar method steps of FIG. 1. In a first step, the personalised training data is received 402. In some embodiments, this method is conducted on the same device that generates the personalised training data and therefore the step of receiving personalised training data comprises obtaining it from memory.

Next, baseline training data and a general purpose machine learning model are obtained or received. Preferably, the general purpose machine learning model is a model that has not been personalised and/or trained using data from a specific individual. Preferably the baseline training data comprises labelled data that is known to be correct. Preferably the baseline training data has been manually labelled. In the example of facial feature identification for avatar generation, baseline training data comprises images labelled with the mood a user is displaying and identifying any areas of interest (such as whether the user is wearing a hat and/or the type and shape of hair they have). Optionally, the baseline training data also comprises high quality synthetic facial images which have been generated previously. Advantageously, synthetic images can come already labelled with the labels that were used in their generation (for example, where a synthetic image was generated with the label “sad”, the output data can have said label associated with it). An example of high quality synthetic facial images could include the personalised output data of the method of FIG. 3 but using a generic synthetic skinned facial mesh instead. High quality syntenic facial images can be rendered via existing game engine technology.

Next, a personalised machine learning model 134 is generated 132 using all of the baseline training data, the baseline general purpose machine learning model, and the personalised training data. Preferably the personalised machine learning model is generated by conducting further training on the general purpose machine learning model with the baseline training data as well as the personalised training data.

With the personalised machine learning model generated, it is then transmitted or otherwise provided 406 to the computing device that is conducting the inference.

Referring to FIG. 5, an example method 500 of updating a first machine learning model is shown. The same or similar reference numerals have been used with the same or similar method steps of FIG. 1. Preferably this method is conducted on the same device that is conducting inference using a first machine learning model. In a first step, the personalised machine learning model is received or obtained 502. Where the personalised machine learning model was generated on the same computing device conducting the present method 500, then the personalised machine learning model is obtained from memory of the same computing device.

Next, a comparison 140 between the accuracy of the first machine learning model currently in use for inference with the received personalised machine learning model. Preferably, the step of comparing the accuracy comprises or is preceded with conducting 504 a step of inference with the first machine learning model and with the personalised machine learning model using the same input data. The outputs of the inferences are compared to check their respective accuracies. Optionally, a user is provided with the machine learning inference output of each machine learning model and/or the output of the inference steps using the machine learning models. Then the user determines which machine learning inference output is more accurate. For example, the user is shown an avatar rendered using the first machine learning model output as well as an avatar rendered using the personalised machine learning model output and then the user selects which avatar is more accurate. This example can be described as A/B testing.

Based on the accuracy of the personalised machine learning model as compared with the accuracy of the first machine learning model, the first machine learning model is replaced with the personalised machine learning model.

Optionally the replaced first machine learning model is kept as a backup in case the new personalised machine learning model is found to be not as accurate, does not operate sufficiently for a given task, and/or the user wishes to select the previous model.

In a further embodiment, this new personalised machine learning model is then used in the creation of further personalised data as set out in step 122. The new personalised machine learning model is used in the rendering and/or synthesis steps as set out above. Thus, using the personalised machine learning model in further training over time results in further personalised machine learning models which are more specific to the individual user.

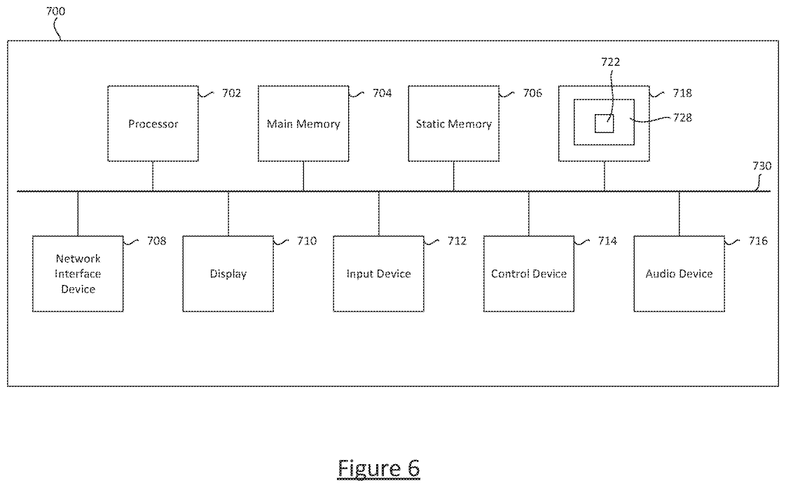

FIG. 6 illustrates a block diagram of one example implementation of a computing device 700 that can be used for implementing any one or more of the data flow and/or method steps indicated in FIGS. 1, 2, 3, 4, and/or 5. The electronic device 202 and/or the server 204 can be implemented using the example hardware of this illustrated computing device. The computing device is associated with executable instructions for causing the computing device to perform any one or more of the methodologies discussed herein. In alternative implementations, the computing device may be connected (e.g., networked) to other machines in a Local Area Network (LAN), an intranet, an extranet, a local wireless network, the Internet, or other appropriate network. The computing device may operate in the capacity of a server or a client machine (or both) in a client-server network environment, or as a peer machine in a peer-to-peer (or distributed) network environment. The computing device may be a personal computer (PC), a tablet computer, a set-top box (STB), a Personal Digital Assistant (PDA), a cellular telephone, a web appliance, a gaming device, a desktop computer, a laptop, a server, or any machine capable of executing a set of instructions (sequential or otherwise) that specify actions to be taken by that machine. Further, while only a single computing device is illustrated, the term “computing device” shall also be taken to include any collection of machines (e.g., computers) that individually or jointly execute a set (or multiple sets) of instructions to perform any one or more of the methodologies discussed herein.

The example computing device 700 includes a processing device 702, a main memory 704 (e.g., read-only memory (ROM), flash memory, dynamic random-access memory (DRAM) such as synchronous DRAM (SDRAM) or Rambus DRAM (RDRAM), etc.), a static memory 706 (e.g., flash memory, static random-access memory (SRAM), etc.), and a secondary memory (e.g., a data storage device 718), which communicate with each other via a bus 730.

Processing device 702 represents one or more general-purpose processors such as a microprocessor, central processing unit, or the like. More particularly, the processing device 702 may be a complex instruction set computing (CISC) microprocessor, reduced instruction set computing (RISC) microprocessor, very long instruction word (VLIW) microprocessor, processor implementing other instruction sets, or processors implementing a combination of instruction sets. Processing device 702 may also be one or more special-purpose processing devices such as an application specific integrated circuit (ASIC), a field programmable gate array (FPGA), a digital signal processor (DSP), network processor, or the like. The processing device 702 is configured to execute the processing logic (instructions 722) for performing the operations and steps discussed herein.

The computing device 700 may further include a network interface device 708. The computing device also may include a video display unit 710 (e.g., a liquid crystal display (LCD) or a cathode ray tube (CRT)), an alphanumeric input device 712 (e.g., a keyboard, touchscreen), a cursor control device 714 (e.g., a mouse, touchscreen), and an audio device 716 (e.g., a speaker). The video display unit optionally is a video display output unit. For example the video display unit is an HDMI connector. The video display unit preferably displays the user avatar as described throughout. The audio device optionally is an audio output unit. For example, the audio output unit is a stereo audio jack or coupled with the HDMI output.

Preferably, the computing device 700 comprises a further interface configured to communicate with other devices, such as an extended reality display device. The further interface may be the network interface 708 as described above, or a different interface depending on the device being connected to. Preferably the interface configured to the extended reality device is such that a video stream from the extended reality display device can be provided to and from the computing device.

The data storage device 718 may include one or more machine-readable storage media (or more specifically one or more non-transitory computer-readable storage media) 728 on which is stored one or more sets of instructions 722 embodying any one or more of the methodologies or functions described herein. The instructions 722 may also reside, completely or at least partially, within the main memory 704 and/or within the processing device 702 during execution thereof by the computer system 700, the main memory 704 and the processing device 702 also constituting computer-readable storage media.

The various methods described above may be implemented by a computer program. The computer program may include computer code arranged to instruct a computer to perform the functions of one or more of the various methods described above. The computer program and/or the code for performing such methods may be provided to an apparatus, such as a computer, on one or more computer readable media or, more generally, a computer program product. The computer readable media may be transitory or non-transitory. The one or more computer readable media could be, for example, an electronic, magnetic, optical, electromagnetic, infrared, or semiconductor system, or a propagation medium for data transmission, for example for downloading the code over the Internet. Alternatively, the one or more computer readable media could take the form of one or more physical computer readable media such as semiconductor or solid-state memory, magnetic tape, a removable computer diskette, a random-access memory (RAM), a read-only memory (ROM), a rigid magnetic disc, and an optical disk, such as a CD-ROM, CD-R/W or DVD.

In an implementation, the modules, components and other features described herein can be implemented as discrete components or integrated in the functionality of hardware components such as ASICS, FPGAs, DSPs or similar devices.

A “hardware component” or “hardware module” is a tangible (e.g., non-transitory) physical component (e.g., a set of one or more processors) capable of performing certain operations and may be configured or arranged in a certain physical manner. A hardware component may include dedicated circuitry or logic that is permanently configured to perform certain operations. A hardware component may be or include a special-purpose processor, such as a field programmable gate array (FPGA) or an ASIC. A hardware component may also include programmable logic or circuitry that is temporarily configured by software to perform certain operations.

Accordingly, the phrase “hardware component” or “hardware module” should be understood to encompass a tangible entity that may be physically constructed, permanently configured (e.g., hardwired), or temporarily configured (e.g., programmed) to operate in a certain manner or to perform certain operations described herein.

In addition, the modules and components can be implemented as firmware or functional circuitry within hardware devices. Further, the modules and components can be implemented in any combination of hardware devices and software components, or only in software (e.g., code stored or otherwise embodied in a machine-readable medium or in a transmission medium).

Unless specifically stated otherwise, as apparent from the following discussion, it is appreciated that throughout the description, discussions utilizing terms such as “determining”, “providing”, “calculating”, “computing,” “identifying”, “combining”, “establishing” , “sending”, “receiving”, “storing”, “estimating”, “checking”, “obtaining” or the like, refer to the actions and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The term “comprising” as used in this specification and claims means “consisting at least in part of”. When interpreting each statement in this specification and claims that includes the term “comprising”, features other than that or those prefaced by the term may also be present. Related terms such as “comprise” and “comprises” are to be interpreted in the same manner.

It is intended that reference to a range of numbers disclosed herein (for example, 1 to 10) also incorporates reference to all rational numbers within that range (for example, 1, 1.1, 2, 3, 3.9, 4, 5, 6, 6.5, 7, 8, 9 and 10) and also any range of rational numbers within that range (for example, 2 to 8, 1.5 to 5.5 and 3.1 to 4.7) and, therefore, all sub-ranges of all ranges expressly disclosed herein are hereby expressly disclosed. These are only examples of what is specifically intended and all possible combinations of numerical values between the lowest value and the highest value enumerated are to be considered to be expressly stated in this application in a similar manner.

As used herein the term “and/or” means “and” or “or”, or both.

As used herein “(s)” following a noun means the plural and/or singular forms of the noun.

The singular reference of an element does not exclude the plural reference of such elements and vice-versa.

It is to be understood that the above description is intended to be illustrative, and not restrictive. The scope of the disclosure should, therefore, be determined with reference to the other implementations will be apparent to those of skill in the art upon reading and understanding the above description. Although the disclosure has been described with reference to specific example implementations, it will be recognized that the disclosure is not limited to the implementations described but can be practiced with modification and alteration within the scope of the appended claims. Accordingly, the specification and drawings are to be regarded in an illustrative sense rather than a restrictive appended claims, along with the full scope of equivalents to which such claims are entitled.

1. A method of dataset generation, the method comprising:
receiving user image data, and
generating personalised training data based on the received user image data, wherein the step of generating personalised training data comprises:
generating a computational model based at least in part on the received user data, and
generating the personalised training data based on the computational model.

2. A method according to claim 1, wherein the computational model is facial mesh comprising a real-world 3D topology, wherein the real-world 3D topology is based on the received user image data.

3. A method according to claim 1, wherein the computation model comprises a facial mesh and a skin based on real-world skin, wherein the real-world skin is based on the received user image data.

4. A method according to claim 2 wherein the personalised training data is labelled based on the computation model.

5. A method according to claim 1, wherein generating the personalised training data comprises one or more of:
capturing a plurality of views of the computation model from different viewing angles;
capturing a plurality of views of the computation model under different lighting conditions.

6. A method according to claim 5, wherein the personalised training data is labelled based on camera placement, and/or lighting features used in capturing the views of the computational model.

7. A method according to claim 1, wherein the personalised training data is based on a parameterised input, wherein the parameterised input represents an area of interest of the user.

8. A method according to 7 wherein the parameterised input represents any one or more of the following:
a facial feature of the user,
facial hair of the user,
hair of the user,
an item of clothing worn by the user,
an accessory worn by the user,
glasses worn by the user, and
a hat worn by the user.

9. A method according to claim 7, wherein the generating the personalised training data comprises:
capturing a plurality of views of the computation model, wherein the computation model is based on the parameterised input, optionally
wherein the personalised training data is labelled based on the parameterised input.

10. A method according to claim 1, wherein the received user image data is processed to crop and select an area of interest of the user, wherein the area of interest comprises the user's face and other surrounding user features.

11. A method according to claim 10, wherein the area of interest comprises the user's face and any one or more of the following:
a facial feature of the user,
facial hair of the user,
hair of the user,
an item of clothing worn by the user,
an accessory worn by the user,
glasses worn by the user, and
a hat worn by the user.

12. A method according to claim 1, further comprising the step of:
receiving a personalised machine learning model.

13. A method of dataset generation and model personalisation, the method comprising:
receiving personalised training data, and
generating a personalised machine learning model by training a general purpose machine learning model based on the personalised training data and based on baseline training data.

14. A method according to claim 13, wherein the personalised machine learning model replaces a previous machine learning model based on a comparison between the generated personalised machine learning model and the previously generated machine learning model.

15. A method according to claim 14, wherein the comparison comprises determining which of the machine learning models provides more accurate outputs.

16. A method according to claim 13, further comprising the step of:
conducting an inference step using a first machine learning model, and wherein the generation of a personalised machine learning model is conducted based on a determination that an output of the inference step is below a threshold accuracy level.

17. An electronic device comprising a processor configured to perform the method according to claim 1.

18. An electronic device comprising a processor configured to perform the method according to claim 13.

19. A non-transitory computer-readable storage medium comprising instructions which, when executed by a computer, cause the computer to carry out the method according to claim 1.

20. A system for data generation and model personalisation comprising:
a first electronic device comprising a processor configured to perform the method according to claim 1, and
a second electronic device operatively coupled to the first electronic device, the second device comprising a processor configured to perform the method according to claim 13, optionally wherein the first electronic device is configured to generate personalised training data, and wherein the second electronic device is configured to receive the personalised training data, generate a new personal machine learning model and provide the new personal machine learning model to the first electronic device.
